(19) United States
(12) Patent Application Publication
(10) Pub. No.: US 2022/0252695 A1
(43) Pub. Date: Aug. 11, 2022

(54) CALIBRATION BODY DEVICE, CALIBRATION BODY SYSTEM AND METHOD FOR CALIBRATING A CAMERA SYSTEM, A DEPTH SENSOR AND/OR A RADAR SYSTEM WITH THE AID OF THE CALIBRATION BODY DEVICE OR THE CALIBRATION BODY SYSTEM

(71) Applicant: Robert Bosch GmbH, Stuttgart (DE)

(72) Inventor: Moritz Michael Knorr, Hildesheim (DE)

(21) Appl. No.: 17/589,390

(22) Filed: Jan. 31, 2022

(30) Foreign Application Priority Data
Feb. 9, 2021 (DE) 10 2021 201 172.1

(51) Int. Cl. G01S 7/40; G01S 7/497; H04N 17/00; H01Q 15/18

(52) U.S. Cl. CPC G01S 7/4082; H01Q 15/18; H04N 17/002; G01S 7/497

(57) ABSTRACT

A calibration body device for calibrating a camera system, a depth sensor, in particular a LIDAR system, and a radar system. The calibration body device includes at least one base body, which includes at least three calibration surfaces fixedly situated relative to one another and oriented differently from one another, which are designed to be radar-reflective. The at least three calibration surfaces each include at least one assignable calibration pattern.

### BACKGROUND INFORMATION

A calibration body device for calibrating a camera system, a depth sensor, in particular a LIDAR system, and a radar system that includes at least one base body, which includes at least three calibration surfaces fixedly situated relative to one another and oriented differently from one another, which are designed to be radar-reflective, has already been provided in the related art.

### SUMMARY

The present invention is directed to a calibration body device for calibrating a camera system, a depth sensor, in particular a LIDAR system, and a radar system, including at least one base body, which includes at least three calibration surfaces fixedly situated relative to one another and oriented differently from one another, which are designed to be radar-reflective.

In accordance with an example embodiment of the present invention, it is provided that the at least three calibration surfaces each include at least one assignable calibration pattern.

With the aid of the design of the calibration body device according to the present invention, a detection is able to take place via camera systems, depth sensors and radar systems. This may enable an advantageously simultaneous calibration of camera systems, depth sensors and radar systems. A cross-calibration of camera systems, depth sensors and radar systems, in particular, may be achieved. This may advantageously enable an intrinsic calibration of camera systems. This may advantageously enable an extrinsic calibration of detection systems, in particular, of camera systems, of depth sensors and of radar systems. An advantageously simple and rapid extrinsic multi-camera calibration, in particular, may be achieved. An advantageously compact calibration system for camera systems, depth sensors and radar systems may be implemented.

In accordance with an example embodiment of the present invention, the calibration patterns are each preferably designed to be recognizable, in particular, from an outer appearance and/or distinguishable from a surface structure of the calibration surfaces. The calibration patterns are preferably each unambiguously assignable. The calibration patterns each include, in particular, at least one visual feature, which distinguishes the respective calibration pattern from the other calibration patterns of the calibration body device. The calibration patterns are preferably each situated centrally or distributed, in particular, uniformly on the calibration surface around a midpoint of one of the calibration surfaces. The calibration patterns each cover preferably at least 30%, preferably at least 50% and preferably at least 70% of a calibration surface. The calibration patterns are preferably each situated spaced apart from outer edges of the calibration surfaces. The calibration patterns extend, in particular, in each case not beyond more than one outer side of the base body or beyond more than one calibration surface of the calibration body device. The individual calibration surfaces of the base body are preferably distinguishable via the calibration patterns. A position and a spatial orientation of the individual calibration surfaces are preferably determinable via the detected calibration patterns.

The calibration body device is preferably provided to enable, in particular, simultaneously, a calibration of camera systems, depth sensors, in particular LIDAR systems, and radar systems. “Provided” is understood to mean, in particular, specifically designed and/or specifically equipped. An object being provided for a particular function is understood to mean, in particular, that the object fulfills and/or executes this particular function in at least one application state and/or operating state. The calibration body device is preferably designed in such a way that the calibration body device, in particular, the calibration surfaces of the calibration body device, is detectable via camera systems, depth sensors such as, for example, LIDAR systems, TOF cameras or the like, and radar systems. The calibration body device is, in particular, not limited to a simultaneous calibration of a camera system, of a depth sensor, in particular of LIDAR systems, and of a radar system. The calibration body device is provided, in particular, also for calibrating a single detection system, in particular, a camera system, a depth sensor, in particular a LIDAR system, or a radar system. The calibration body device is preferably provided for a cross-calibration of multiple detection systems, in particular, of a camera system, of a depth sensor, in particular of a LIDAR system, and/or of a radar system. For example, the calibration body device is provided for calibrating detection systems from the automotive sector, for example, in a vehicle. The calibration body device is provided, in particular, for calibrating detection systems of a semi-autonomous or fully autonomous robot or vehicle. A “camera system” is understood to mean, in particular, a system that includes at least one camera, in particular, a plurality of cameras. The camera system is preferably not limited to a specific design of the camera(s). For example, the camera(s) is/are designed as a monocular camera, as a stereo camera or the like. The camera(s) preferably includes/include at least one image sensor for recording two-dimensional images. A “radar system” is understood to mean, in particular, a system that is provided for detecting surroundings with the aid of a recognition method and/or position finding method on the basis of electromagnetic waves in the radio frequency range. The radar system preferably includes at least one radar antenna and/or at least one radar sensor for emitting and/or for receiving electromagnetic waves.

The calibration body device preferably includes exactly one, in particular, the aforementioned, base body. It is possible that the base body includes more than three calibration surfaces. The calibration surfaces are preferably formed from at least an electroconductive material, in particular, from a metal. The base body is preferably formed in one area of the calibration surfaces from the electroconductive material, in particular, from the metal. It is possible that the base body is formed essentially completely from the electroconductive material, in particular, from the metal, as a result of which, in particular, an advantageously high degree of stability and/or advantageously consistent reflection properties is/are able to be achieved in the case of wear and tear or damage.

The calibration surfaces are preferably designed in such a way that radiation in a wavelength range of a depth sensor to be calibrated is, at least to a large part, not reflected at the calibration surfaces. The calibration surfaces for a laser are, in particular, designed not be fully reflective. The calibration surfaces are preferably each non-coated. One shape of the individual calibration surfaces is preferably known. The at least three calibration surfaces preferably have an at least essentially identical base form. It is also possible that the at least three calibration surfaces have base forms differing from one another and are, in particular, distinguishable from one another via their base form. In one preferred embodiment of the present invention, the base body forms for each or for each second calibration surface of the base body at least one wall, the base body forming, in particular, at least three walls. Each wall of the base body preferably includes one calibration surface or two calibration surfaces. The walls of the base body preferably have an essentially plate-like design. “An essentially plate-like design” is understood to mean, in particular, a design of a spatial element, in particular, of a wall of the base body which, as viewed in one development in a plane, exhibits an, in particular, at least essentially consistent material thickness perpendicularly to the plane, which is less than 50% and particularly preferably less than 25% and most preferably less than 10% of a surface extension of the spatial element in parallel to a plane, in particular, of a smallest surface extension of the element in parallel to the plane.

In addition, it is provided that the base body is designed as one piece with the at least three calibration surfaces. An advantageously compact design may be achieved. This may enable an advantageously smaller required detection area for a calibration at the calibration device. “As one piece” is understood to mean, in particular, materially joined such as, for example, by a welding process and/or bonding process, etc., and/or particularly advantageously molded on, as produced from a cast or the like. The base is formed, in particular, from one piece and/or joined together from individual parts, preferably from the walls of the base body, via a welding process and/or bonding process. The walls, including, in particular, the calibration surfaces and/or the calibration surfaces are directly adjoined to one another, two each of the calibration surfaces, in particular, forming in each case at least one edge and/or one point of intersection. Alternatively, it is possible that the base body has a multi-part design, the at least three calibration surfaces or the components of the base body including the at least three calibration surfaces being permanently fixed to one another, for example, via a screw connection or the like.

It is also provided that the at least three calibration surfaces are situated at least essentially perpendicularly to one another. Good reflection properties for radar systems may be advantageously achieved. An advantageously simple and rapid assignment of the calibration surfaces and/or of the calibration patterns in space may take place. “Essentially perpendicularly” is understood to mean, in particular, an orientation of a straight line, of a plane or of a direction, in particular, of a main extension plane of the calibration surfaces, relative to another straight line, to another plane or to a reference direction, in particular, to a main extension plane of one other calibration surface of the calibration surfaces, the straight line, the plane or the direction and the other straight line, the other plane or the other reference direction, as viewed in particular, in a projection plane, encompassing an angle of 90° with a maximum deviation of, in particular, less than 5°, advantageously less than 3° and particularly advantageously less than 2°. A “main extension plane” of a structural unit, in particular, of one of the calibration surfaces, is understood to mean, in particular, a plane which is in parallel to a largest lateral surface of a smallest possible cuboid, which barely completely surrounds the structural unit and, in particular, which extends through the midpoint of the cuboid. The base body, in particular, the calibration surfaces together, is formed as at least one radar triple mirror. The base body, in particular, the calibration surfaces together, is designed at least as one triangular angle reflector. The base body, in particular, the calibration surfaces together, in particular, is designed as a section of a cube. It is possible that the base body includes more than three calibration surfaces, in each case, in particular, at least three calibration surfaces situated, in particular, adjoined to one another, being situated essentially perpendicularly to one another. For example, the base body has at least essentially a tetrahedral base form, which barely fully encompasses the base body. It is also possible that the base form of the base body is designed at least essentially as an octahedron or the like. The calibration surfaces are preferably situated spaced apart from virtual outer surface of the base form of the base body. The calibration surfaces are situated, in particular, within the base form of the base body. In one embodiment of the calibration body device including more than three calibration surfaces, preferably at least three of the calibration surfaces of the calibration body device are situated at least essentially perpendicularly to one another.

In accordance with an example embodiment of the present invention, it is further provided that the at least three calibration surfaces each have an essentially planar design. This may enable an advantageously simple and rapid determination of distances on the calibration surfaces. This may enable an advantageously simple and exact recognition of the calibration pattern on the calibration surfaces. Good reflection properties of the calibration surfaces may be advantageously achieved. “Essentially planar” is understood to mean, in particular, a design of a surface, in particular of the individual calibration surfaces, all points within the surface lying at least essentially on a main extension plane of the surface, preferably at a maximum distance oriented perpendicularly to a main extension plane of the surface of no more than 5%, preferably no more than 3% and particularly preferably no more than 1% to the main extension plane of the surface. The aforementioned maximum distance of the points of the surface to the main extension plane of the surface corresponds to a manufacturing tolerance and/or machine tolerance of the component and/or material including the surface, in particular, of the base body and/or of the material of the base body.

It is further provided that the at least three calibration surfaces are adjoined to one another, the at least three calibration surfaces forming a point of intersection and/or in each case two of the at least three calibration surfaces forming a cut edge. This may enable an advantageously simple and rapid cross-calibration between multiple detection systems, in particular, between camera systems and depth sensors. An additional computing effort for determining virtual points of intersection and/or cut edges of the calibration surface may be advantageously omitted. Alternatively or in addition, it is possible that the at least one point of intersection and/or the cut edge(s) is/are at least partially or completely virtually formed. For example, two each of the at least three calibration surfaces form a cut edge and delimit a recess in one area of a virtual point of intersection of the three calibration surfaces. Other designs of the base body, in particular, of the calibration surfaces, are, however, also possible. The cut edges are preferably designed in each case to be at least essentially straight. The expression “at least essentially straight” is intended to describe a line, in particular, a line along one of the cut edges, which extends completely along a main extension axis of the line, each point on the line perpendicular to the main extension axis of the line having a maximum distance to the main extension axis of the line of no more than 5%, preferably no more than 3% and preferably no more than 1% of a maximum longitudinal extension of the line. A “main extension axis” of an object, in particular, of the line, is understood in this case to mean, in particular, an axis that extends in parallel to a longest edge of a smallest geometrical cuboid, which barely completely encompasses the object. The point of intersection of the calibration surfaces preferably forms a reflection point for electromagnetic waves in the radio frequency range.

In accordance with an example embodiment of the present invention, it is also provided that the base body has a maximum main extension of no more than 2 m, preferably no more than 1.5 m and preferably no more than 1 m. An advantageously compact design may be achieved. This may enable an advantageously simple and rapid repositioning of the calibration body device, preferably manually and/or without further technical means. The maximum main extension of the base body is, in particular, at least 5 cm, preferably at least 10 cm and preferably at least 15 cm. The maximum main extension of the base body corresponds preferably to a maximum main extension of the/of one of the calibration surfaces. The maximum main extension of the base body extends preferably diagonally or at least essentially perpendicularly to the individual calibration surfaces. The individual cut edges of the calibration surface each preferably have a maximum longitudinal extension of at least 10 cm, preferably at least 20 cm and preferably at least 30 cm. The maximum longitudinal extension of the individual cut edges of the calibration surfaces is preferably no more than 2 m, preferably no more than 1.5 m and preferably no more than 1 m.

In accordance with an example embodiment of the present invention, it is further provided that the calibration patterns of the at least three calibration surfaces each include at least three markers formed differently from one another, the individual calibration surfaces being clearly identifiable via their markers and/or a spatial orientation of the individual calibration surface being ascertainable via the markers. This may enable an advantageously simple and rapid determination of an orientation of the calibration body device in space or relative to the detection systems. An orientation of the individual calibration surfaces relative to one another may be determined in an advantageously simple and rapid manner. Using a fully detected calibration pattern, it is preferably possible to advantageously ascertain an orientation and/or a position of non-visible or only partially visible other calibration patterns or the calibration surfaces that include the calibration patterns. A “marker” is understood to mean, in particular, a visually recognizable feature, which is identifiable via at least one color value profile and/or gray scale profile. It is possible that each calibration pattern includes in each case a plurality, in particular, more than three, markers. It is possible that the marker/markers itself/themselves is/are designed as an unambiguously identifiable pattern. The at least three markers differing from one another each form, in particular, one of the calibration patterns. The at least three markers of a calibration surface formed differently from one another are preferably provided for the purpose of forming the calibration surface unambiguously identifiable among the at least three calibration surfaces of the calibration body device via their design and/or via an arrangement of the markers on the calibration surface. The at least three markers of a calibration surface formed differently from one another are preferably provided for the purpose of indicating via an arrangement of the three markers on the calibration surface relative to one another a position of the other calibration surfaces of the calibration body device relative to the calibration surface in space. In one preferred embodiment of the calibration body device, at least one portion of the markers form a checkerboard pattern. Alternatively or in addition, it is possible that the calibration patterns, in addition to the markers, have a checkerboard pattern. For example, the at least three markers formed differently from one another of a calibration pattern, which is situated on one calibration surface, are each situated at sides of the checkerboard pattern, which face another calibration surface of the calibration body device. Other designs of the calibration patterns, in particular, of the markers, are, however, also possible. Alternatively or in addition to the aforementioned checkerboard pattern, other designs of patterns, to be used, in particular, alternatively or in addition to the patterns are, however, also possible. Alternatively or in addition, it is possible that the calibration patterns each include a highly accurate visual marking, which is made up of an arrangement of a plurality of structures and substructures, the markers being designed, for example, as minimal recognition areas of the marking. A “minimal recognition area” is understood to mean, in particular, a smallest structure arrangement made up of structures and substructures of the visual markings adjacent to one another, which occur exactly once within the visual marking and/or the calibration pattern. The minimal recognition areas each preferably include a particular number of the structures and/or of the substructures, which are unambiguously assignable via an arrangement to one another and/or via an exact number of the structures and/or of the substructures in the respective calibration pattern and/or in the calibration body device. For example, the calibration patterns each include a regular pattern made up of a plurality of square structures and a plurality of substructures, which are situated in each case, in particular, completely or partially, within one of the structures, in each case at least two directly adjacent structures, as viewed in at least two directions oriented perpendicularly to one another along a projection plane of the visual marking, having colors differing from one another, a color sequence of the plurality of structures periodically repeating along the two directions.

In accordance with an example embodiment of the present invention, it is further provided that at least one calibration pattern of one of the calibration surfaces includes at least one piece of coded information, in particular, a piece of calibration information. An advantageously high degree of functionality and flexibility of the calibration body device may be achieved, in particular since, for example, relevant pieces of information may be directly conveyed via the calibration pattern/calibration patterns for a calibration of detection systems with the aid of the calibration body device, a number of pieces of necessary information to be conveyed externally beforehand for using the calibration body device being capable of being advantageously reduced. Pieces of information may preferably be conveyed via a detection of the calibration pattern or of a subarea of the calibration pattern, in particular, independently of further sensors or the like. For example, the information is designed as a geometric variable within the calibration pattern, as viewed, in particular, in a fixed projection plane relative to a detection system or in a calibration surface that includes the calibration pattern. It is possible, in particular, that the information also includes a reference plane for the geometric variable such as, for example, the aforementioned projection plane. Alternatively or in addition, it is possible that the information is an identification number of the calibration surface that includes the calibration pattern, which includes the calibration body device including the calibration pattern, and/or of the calibration pattern. In one preferred embodiment, the at least one piece of information is provided for the purpose of conveying, for example, a linear measure within the calibration pattern, a linear measure of the calibration surface that includes calibration pattern and/or a linear measure of the calibration body device that includes the calibration pattern, in particular, during a detection of the represented calibration pattern, for example, a range to the calibration body device and/or a size of the calibration body device being capable of being ascertained. A “piece of calibration information” is understood to mean, in particular, a piece of information, which facilitates and/or enables a calibration of a detection system. For example, the calibration information is designed as a position of the calibration body device, in particular, of the calibration surface that includes the respective calibration pattern, as a measure of a distance of markers of the respective calibration pattern and/or of a marker of the respective calibration pattern to a cut edge or to a point of intersection of calibration surfaces or the like.

In accordance with an example embodiment of the present invention, a calibration body system for calibrating a camera system, a depth sensor, in particular a LIDAR sensor, and a radar system including at least two calibration body devices according to the present invention is also provided, the calibration body devices being designed in such a way that and/or, in particular, being situated relative to one another in such a way that, as viewed along at least one detection direction, an unambiguous assignment of the individual calibration body devices is enabled.

As a result of the design of the calibration body system according to the present invention, a detection via camera systems, depth sensors and radar systems is able to take place. This may enable an advantageously simultaneous calibration of camera systems, depth sensors and radar systems. A cross-calibration of camera systems, depth sensors and radar systems, in particular, may be achieved. This may advantageously enable an intrinsic calibration of camera systems. This may advantageously enable an extrinsic calibration of detection systems, in particular, camera systems, depth sensors and radar systems. An advantageously simple and rapid extrinsic multi-camera calibration, in particular, may be achieved. An advantageously compact calibration system for camera systems, depth sensors and radar systems may be advantageously implemented. A large detection area for calibrating detection systems such as, for example, in a detection area of an automobile, may be advantageously simply covered.

The calibration body devices of the calibration body system, in particular, with the exception of the calibration pattern, preferably have an at least essentially identical structural design. It is possible that the calibration body devices of the calibration body system are each unambiguously assignable via the calibration pattern. Alternatively or in addition, the calibration body devices of the calibration body system are each unambiguously assignable via their arrangement relative to the detection direction. The calibration body system, in particular, the calibration body device(s), in particular, is/are provided for the purpose of enabling a calibration of detection systems via a detection of the calibration body system, in particular of the calibration body device(s), from the detection direction.

It is also provided that the at least two calibration body devices, as viewed along the detection direction, are spaced apart from one another and are situated offset from one another in the detection direction. An unambiguous assignment of the individual calibration body devices during a detection of the calibration body devices may take place in an advantageously simple and rapid manner. Each of the calibration body devices of the calibration body system preferably has another minimal distance in each case to a reference point or to one of the calibration body devices. The minimal distance of the individual calibration body devices extends, in particular, at least essentially in parallel to the detection direction. “Essentially in parallel” is understood to mean, in particular, an orientation of a straight line, of a plane or of a direction, in particular, of a straight line, in each case including a minimal distance of the individual calibration body devices, relative to another straight line, to another plane or to a reference direction, in particular, to a straight line extending along the detection direction, the straight line, the plane or the direction as opposed to the other straight line, the other plane or the reference direction, as viewed, in particular, in a projection plane, having a deviation of, in particular, less than 8°, advantageously less than 5° and particularly advantageously less than 2°. Alternatively or in addition, it is possible that the at least two calibration body devices, as viewed along the detection direction, are situated offset to one another and situated transversely, in particular, at least essentially perpendicularly to the detection direction at different distances to one another. For example, each calibration body device of the calibration body system exhibits in each case another minimal distance to a reference point or to one of the calibration body devices, preferably in a plane extending transversely or at least essentially perpendicularly to the detection direction.

A method for calibrating a camera system, a depth sensor, in particular a LIDAR system, and/or a radar system with the aid of a calibration body device according to the present invention or with the aid of a calibration body system according to the present invention is also provided.

As a result of the design of the method according to the present invention, a detection via camera systems, depth sensors and radar systems is able to take place. This may enable an advantageously simultaneous calibration of camera systems, of depth sensor systems and of radar systems. A cross-calibration of camera systems, depth sensors and radar systems, in particular, may be advantageously achieved. This may advantageously enable an intrinsic calibration of camera systems. This may advantageously enable an extrinsic calibration of detection systems, in particular, of camera systems, of depth sensors and of radar systems. An advantageously simple and rapid extrinsic multi-camera calibration, in particular, may be achieved. This may enable an advantageously simple and efficient calibration of detection systems, in particular, of camera systems, of depth sensors and of radar systems, in particular, since additional calibration devices may be omitted.

In accordance with an example embodiment of the present invention, the calibration body device or the calibration body system is preferably situated in such a way that all calibration surfaces of the/of one or of all calibration body device(s) for the respective detection system(s) to be calibrated, in particular, the camera system, the depth sensor and/or the radar system, are visible. The calibration body device or the calibration body system is preferably situated in such a way that all calibration surfaces of the/of one or of all calibration body device(s) face at least partially the respective detection system(s), in particular, the camera system, the depth sensor and/or the radar system. A form of the individual calibration surfaces is preferably stored in at least one method step, in particular before a calibration of a detection system. An adaptation of a detection algorithm, for example, for determining a spatial orientation of the calibration body device, in particular, takes place in at least one method step, as a function of a comparison of a form of at least one of the calibration surfaces, detected for example, via the camera system, with a stored form of the respective calibration surface.

The method is preferably provided for calibrating detection systems, in particular camera systems, depth sensor systems, in particular LIDAR systems, and/or radar systems, from the automotive sector, in particular, of a vehicle, with the aid of at least one calibration body device or of one calibration body system. The method is provided, in particular, for calibrating detection systems of a semi-autonomous or fully autonomous robot or vehicle with the aid of at least one calibration body device or of one calibration body system. Other fields of application of the method are, however, also possible, for example, for calibrating drones or other robots or the like. In at least one method step, the/a calibration body device or the calibration body system is preferably positioned at particular known points relative to one or to multiple detection system(s), an extrinsic calibration to a system that includes the detection system such as, for example, to a vehicle, being enabled. In the exemplary embodiment, the points for positioning the calibration body device or the calibration body system are formed as points on a vehicle axis or in a plane with a ground on which the vehicle is situated.

It is further provided that in at least one method step at least one camera system is calibrated via a detection of at least three unambiguously assignable calibration patterns of the calibration body device, at least one depth sensor, in particular a LIDAR system, is calculated via at least three calibration surfaces of the calibration body device, and/or at last one radar system is calibrated via a reflection point formed by the calibration surfaces for electromagnetic waves in the radio frequency range, a calibration of the camera system and/or a calibration of the depth sensor and/or a calibration of the radar system taking place at least essentially simultaneously. This may enable an advantageously simple and efficient calibration of detection systems, in particular, of camera systems, of depth sensors and of radar systems. “Essentially simultaneously” is understood to mean, in particular, that two or multiple activities take place within one method step. The two or more activities take place preferably without change to the surrounding conditions such as, for example, a movement of the calibration body device or the like. The calibration body system and/or the calibration body device is/are preferably provided for the purpose of enabling an at least essentially simultaneous calibration of the/of one camera system via a detection of at least three unambiguously assignable calibration patterns of the calibration body device, of a/of the depth sensor, in particular of the LIDAR system, via at least three calibration surfaces of the calibration body device and/or of one/of the radar system via a reflection point formed by the calibration surfaces for electromagnetic waves in the radio frequency range.

In at least one method step, a cross-calibration between the camera system and the depth sensor and/or an extrinsic calibration of the camera system and/or of the depth sensor preferably takes place via the depth sensor with the aid of a detection of the calibration pattern via a, in particular the aforementioned, camera system and with the aid of a detection of a, in particular the aforementioned, point of intersection and, in particular, of the aforementioned cut edges between the calibration surfaces of the/of a calibration body device. In at least one method step, at least one distance or at least one range within a detection area of a detection system that includes the calibration body device is ascertained with the aid of at least one, in particular, the aforementioned, point of intersection of the calibration surfaces of the/of a calibration body device, with the aid of at least one cut edge between two of the calibration surfaces of the/of a calibration body device and/or with the aid of at least one visual feature of one of the calibration patterns of the/of a calibration body device. It is possible that in at least one method step, an in particular, extrinsic, multi-camera calibration, preferably of multiple cameras systems and/or of multiple cameras of a/of the camera system takes place via a detection of calibration patterns of a calibration body device.

The calibration body device according to the present invention, the calibration body system according to the present invention and/or the method according to the present invention is/are not intended to be limited to the application and specific embodiment described above. The calibration body device according to the present invention, the calibration body system according to the present invention and/or the method according to the present invention may, in particular, include a number differing from a number of individual elements, components and units as well as method steps for fulfilling an operating principle described herein. In addition, values in the value ranges indicated in this description also lying within the cited limits are also to be considered described and arbitrarily usable.

### BRIEF DESCRIPTION OF THE DRAWINGS

Further advantages result from the following description of the figures. Two exemplary embodiments of the present invention are represented in the figures. The figures and the description herein contain numerous features in combination. Those skilled in the art will advantageously also consider the features individually and combine them to form meaningful further combinations, in view of the disclosure herein.

FIG. 1 schematically shows a representation of a calibration body device according to an example embodiment the present invention of a calibration body system according to an example embodiment of the present invention for calibrating a camera system, a depth sensor, in particular a LIDAR system, and a radar system in a perspective view.

FIG. 2 schematically shows a representation of a first exemplary arrangement of calibration body devices according to the present invention of the calibration body system according to an example embodiment of the present invention.

FIG. 3 schematically shows a representation of a second exemplary arrangement of the calibration body devices according to the present invention of the calibration body system according to an example embodiment of the present invention,

FIG. 4 schematically shows a representation of a third exemplary arrangement of the calibration body devices according to the present invention of the calibration body system according to an example embodiment of the present invention.

FIG. 5 schematically shows a representation of an exemplary sequence of a method according to the present invention for calibrating a camera system, a depth sensor, in particular a LIDAR system, and/or a radar system with the aid of one of the calibration body devices according to an example embodiment of the present invention or with the aid of the calibration body system according to an example embodiment of the present invention.

FIG. 6 schematically shows a representation of an alternative embodiment of a calibration body device according to an example embodiment of the present invention in a perspective view.

### DETAILED DESCRIPTION OF EXAMPLE EMBODIMENTS

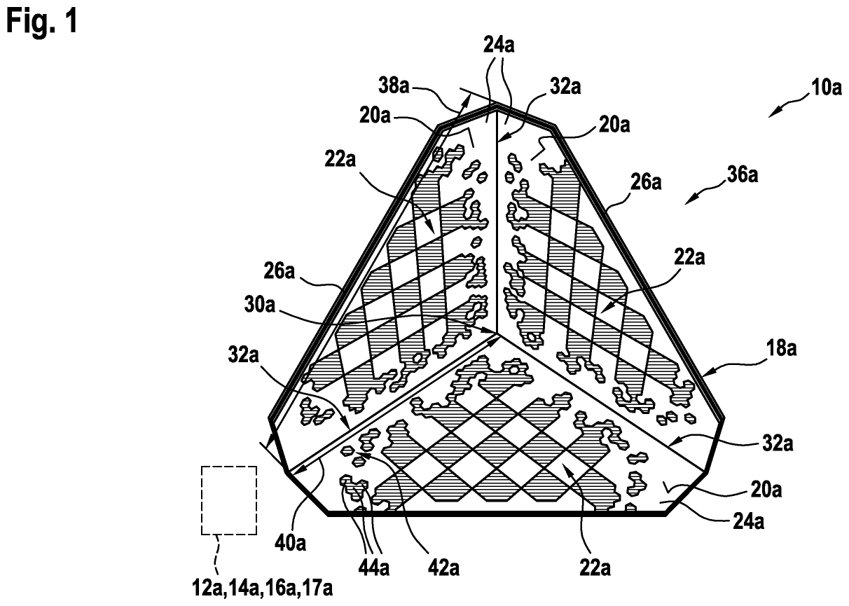

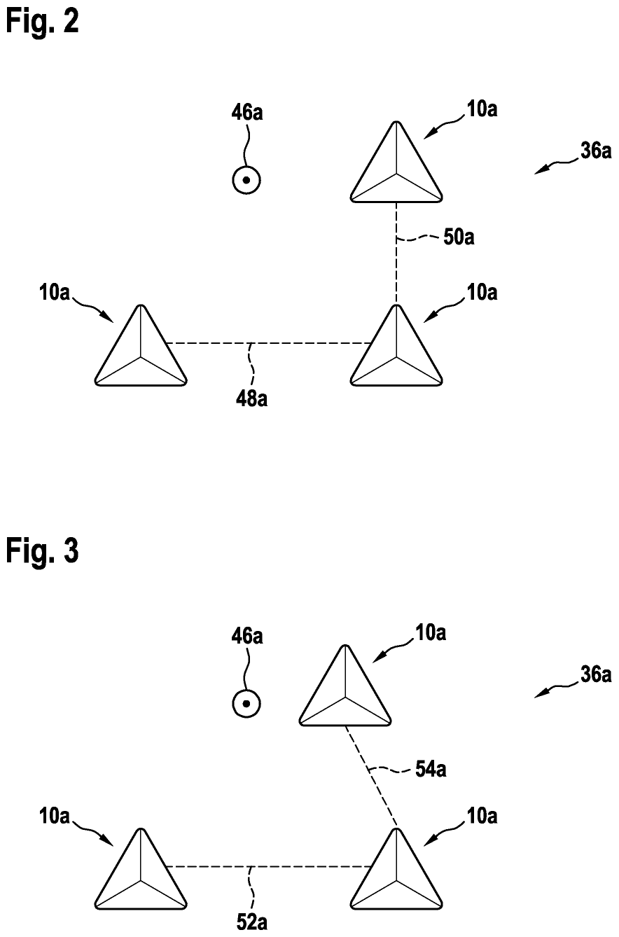

FIG. 1 shows a calibration body device 10a for calibrating a camera system 12a, a depth sensor 14a, in particular a LIDAR system, and a radar system 16a (as detection systems 17a). Calibration body device 10a includes a base body 18a, which includes three calibration surfaces 20a fixedly situated relative to one another and oriented differently from one another. Calibration surfaces 20a are designed to be radar-reflective. The three calibration surfaces 20a are each formed from a non-coated metal sheet. The three calibration surfaces 20a each include an assignable calibration pattern 22a. Base body 18a includes three walls 24a, each of which forms one of calibration surfaces 20a. Walls 24a each have an at least essentially plate-like design. Base body 18a including the three calibration surfaces 20a has a multi-part design. Walls 24a are fastened to one another via struts 26a and screw connections. It is preferably possible that base body 18a is designed as one piece, walls 24a, in particular, being welded to struts 26a or directly to one another or the like. Other designs of base body 18a are also possible, for example, base body 18a being formed from one piece. The three calibration surfaces 20a are situated at least essentially perpendicularly, preferably perpendicularly to one another. The three calibration surfaces 20a are directly joined to one another. The three calibration surfaces 20a each have at least essentially a planar design. The three calibration surfaces 20a form a shared point of intersection 30a. Two each of calibration surfaces 20a of the three calibration surfaces 20a form a cut edge 32a. Cut edges 32a between calibration surfaces 20a are each formed at least essentially straight. Base body 18a, in particular, walls 24a of base body 18a, forms a triple mirror. Calibration body device 10a is provided for carrying out a method 34a for calibrating camera system 12a, depth sensor 14a and/or radar system 16a. Calibration body device 10a is formed as part of a calibration body system 36a for calibrating camera system 12a, depth sensor 14a and radar system 16a (see also FIGS. 2 through 4). Calibration body system 36a is provided, in particular, for carrying out method 34a.

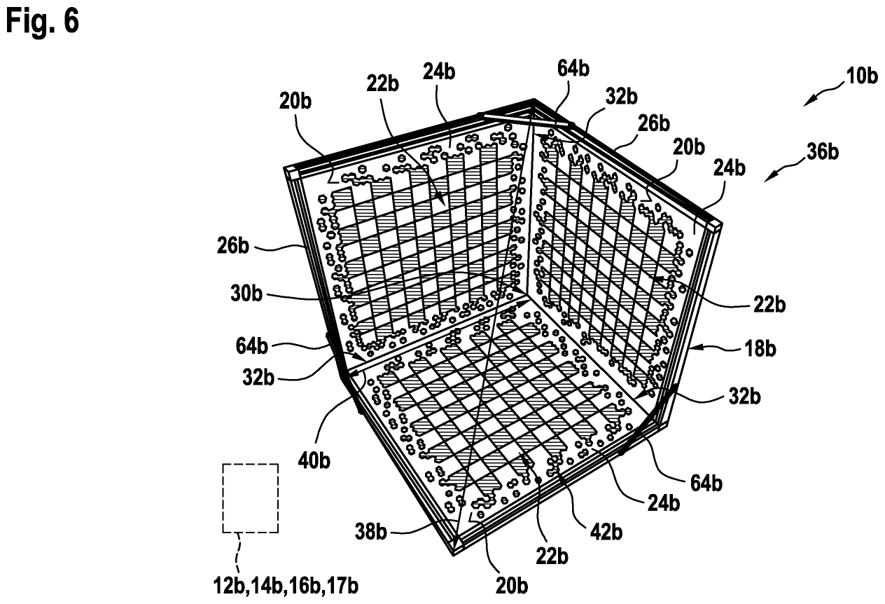

Base body 18a has a maximum main extension 38a of at least essentially 1 m. Maximum main extension 38a of base body 18a is preferably no more than 2 m, preferably no more than 1.5 m and preferably no more than 1 m. Maximum main extension 38a of base body 18a extends diagonally to calibration surfaces 20a. Base body 18a has a maximum extension 40a in parallel to individual cut edges 32a of calibration surfaces 20a in each case of no more than 1.42 m, preferably no more than 1.07 m and preferably no more than 0.71 m. Calibration surfaces 20a each have an at least essentially triangular base form including two truncated edges. Other designs of the base form of calibration surfaces 20a are also possible, for example, a completely triangular base form, an equilateral triangular base form or also a base form designed differently from a triangle (cf. FIG. 6). The three calibration surfaces 20a preferably have an at least essentially identical base form. It is also possible that calibration surfaces 20a have base forms differing from one another. Cut edges 32a of calibration surfaces 20a merge in point of intersection 30a, which acts as a reflection point for electromagnetic waves in the radio frequency range. It is also possible that base body 18a, in particular walls 24a, delimits a recess in a merging area of cut edges 32a, point of intersection 30a and/or parts of cut edges 32a being virtually designed.

Calibration patterns 22a are shown by way of example in FIG. 1. Calibration patterns 22a each have a checkerboard pattern and additional visual markings at the sides of the checkerboard pattern. The checkerboard pattern enables, in particular, in the case of a known size of the individual boxes of the checkerboard pattern, in particular, an ascertainment of distances and masses via detection systems 17a, in particular, camera system 12a. Calibration patterns 22a of the three calibration surfaces 20a each include a plurality of markers 42a designed differently from one another, the individual calibration surfaces 20a being unambiguously identifiable via their markers 42a and/or a spatial orientation of individual calibration surfaces 20a being ascertainable via markers 42a. The visual markings form markers 42a. The visual markings are situated on one of calibration surfaces 20a, in each case at a side of calibration pattern 22a of calibration surface 20a including the visual marking that faces another calibration surface 20a of calibration surfaces 20a. The visual markings are each designed as minimum recognition areas, each of which includes a plurality of hexagonal structures 44a. The minimum recognition areas differ in each case via an arrangement of hexagonal structures 44a within a base surface of the minimum recognition areas, which extends, in particular, within calibration surface 20a. The checkerboard pattern has, in particular, a black and white design. Markers 42a have, in particular, a black and white design. It is also possible that the checkerboard pattern and/or markers 42a are formed from different gray tones and/or from different colors, preferably having different brightness levels. The design of markers 42a of calibration patterns 22a shown in FIG. 1 is merely an exemplary design. Other designs of calibration patterns 22a or of markers 42a are also possible, individual calibration surfaces 20a being unambiguously identifiable via their markers 42a and/or a spatial orientation of individual calibration surfaces 20a being ascertainable via markers 42a.

Calibration patterns 22a of calibration surfaces 20a each include a piece of coded information, which is designed, in particular, as a piece of calibration information. In calibration patterns 22a shown in FIG. 1, the information is coded preferably via the visual markings or via markers 42a. For example, exactly one minimum recognition area is repeated in all three calibration patterns 22a of calibration body device 10a, an arrangement of hexagonal structures 44a, for example, being provided within the repeating minimum recognition area for the purpose of conveying the information. Alternatively or in addition, it is possible that one or multiple calibration patterns 22a of calibration body device 10a includes/include at least one marker 42a designed as a barcode, as a QR code or as another conventional coding code, which is/are provided for conveying the information.

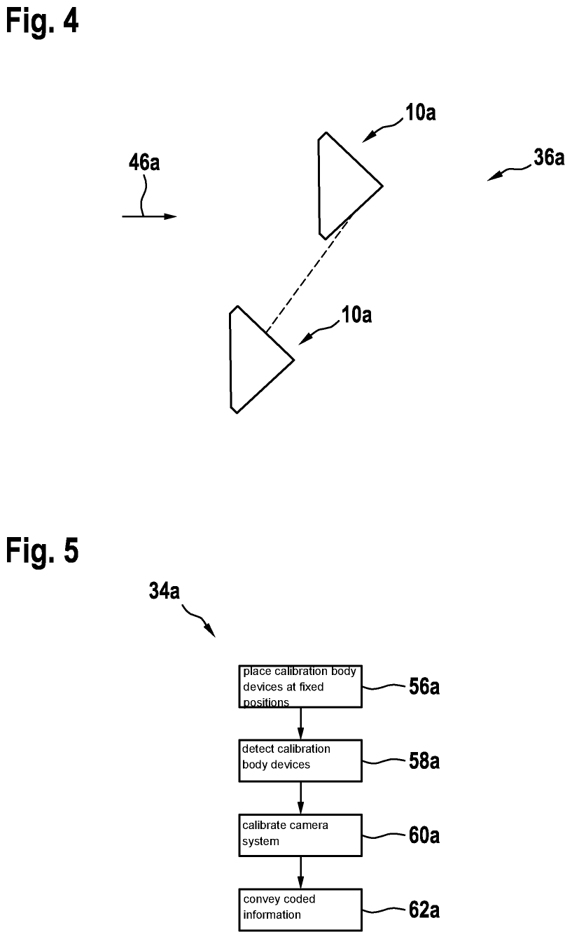

Calibration body system 36a is shown in FIGS. 2 through 4. Calibration body system 36a includes three calibration body devices 10a which, in particular, except for calibration patterns 22a of individual calibration body devices 10a, have at least an essentially structurally identical design. Calibration body devices 10a of calibration body systems 36a are each only schematically shown in FIGS. 2 through 4. Calibration body devices 10a of calibration body system 36a, in particular, have a design similar to calibration body device 10a shown in FIG. 1. Calibration body devices 10a of calibration body system 36a differ preferably via the design of calibration patterns 22a of individual calibration body devices 10a. Calibration body devices 10a of calibration body system 36a are preferably distinguishable from one another via the design of calibration patterns 22a and are preferably individually unambiguously identifiable. Calibration body devices 10a are situated relative to one another in such a way that, as viewed along at least one detection direction 46a, an unambiguous assignment of individual calibration body devices 10a is enabled. A first exemplary arrangement of calibration body devices 10a of calibration body system 36a is shown in FIG. 2, the three calibration body devices 10a each having different distances 48a, 50a relative to one another. A second exemplary arrangement of calibration body devices 10a of calibration body system 36a is shown in FIG. 3, the three calibration body devices 10a each having different distances 52a, 54a relative to one another and a different orientation relative to one another. A third exemplary arrangement of calibration body devices 10a of calibration body system 36a is shown in FIG. 4. Two calibration body devices 10a of calibration body devices 10a of calibration body system 36a, as viewed along detection direction 46a, are situated spaced apart from one another and offset from one another in detection direction 46a.

An exemplary sequence of method 34a for calibrating a camera system 12a, a depth sensor 14a, in particular a LIDAR system, and/or a radar system 16a with the aid of calibration body device 10a or with the aid of calibration body system 36a is shown in FIG. 5. In one method steps 56a of method 34a, calibration body device(s) 10a is/are placed at fixed positions relative to detection systems 17a, in particular, to camera system 12a, to depth sensor 14a and to radar system 16a. In a further method step 58a of method 34a, calibration body device(s) 10a is/are detected via detection systems 17a. In a further method step 60a of method 34a, camera system 12a is calibrated via a detection of the three unambiguously assignable calibration patterns 22a of the/of a calibration body device 10a, depth sensor 14a calibrated via calibration surfaces 20a of the/of a calibration body device 10a, and radar system 16a calibrated via the reflection point for electromagnetic waves in the radio frequency range formed by calibration surfaces 20a in point of intersection 30a, a calibration of camera system 12a, a calibration of depth sensor 14a and a calibration of radar system 16a taking place at least essentially simultaneously. It is also possible that in each case merely two or merely one of detection systems 17a is/are calibrated at least essentially simultaneously. The design of calibration body device(s) 10a and calibration body system 36a enables an at least essentially simultaneous calibration of detection systems 17a. It is possible that in one method step of method 34a, in particular, in method step 60a, a cross-calibration between camera system 12a and depth sensor 14a and/or an extrinsic calibration of camera system 12a and/or of depth sensor 14a takes place with the aid of a detection of calibration pattern 22a via camera system 12a and with the aid of a detection of point of intersection 30a and cut edges 32a between calibration surfaces 20a via depth sensor 14a. In one further method step 62a of method 34a, the coded information is conveyed via a detection of calibration patterns 22a. By evaluating the information, it is possible, for example, to ascertain a distance within calibration body device 10a such as, in particular, a distance of two markers 42a or a distance of one marker 42a to a cut edge 32a or to an outer edge of a calibration surface 20a of calibration body device 10a. It is possible that in one method step of method 34a, in particular, in method step 62a or in a further method step (not shown in FIG. 5), at least one distance or at least one range within a detection area of one of detection systems 17a that includes calibration body device 10a is ascertained with the aid of point of intersection 30a of calibration surfaces 20a, with the aid of the/of one of cut edge(s) 32a between two of the calibration surfaces 20a and/or with the aid of at least one visual feature, in particular, of marker 42a, of calibration pattern 22a. For example, a distance from one of detection systems 17a to calibration body device 10a may be ascertained.

One further exemplary embodiment of the present invention is shown in FIG. 6. The following description and the drawings are restricted essentially to the differences between the exemplary embodiments, where reference may be made with respect to identically identified components, in particular, with respect to components having the same reference numeral, in principle also to the drawings and/or to the description of the other exemplary embodiment, in particular, to FIGS. 1 through 5. To distinguish between exemplary embodiments, the letter a is placed after the reference numerals of the exemplary embodiment in FIGS. 1 through 5. In the exemplary embodiment of FIG. 6, the letter a is replaced by the letter b.

One alternative design of a calibration body device 10b for calibrating a camera system 12b, a depth sensor 14b, in particular a LIDAR system, and a radar system 16b is shown in FIG. 6. Calibration device 10b includes a base body 18b, which includes three calibration surfaces 20b fixedly situated relative to one another and oriented differently from one another, which are designed to be radar-reflective. The three calibration surfaces 20b each include at least one, preferably unambiguously assignable, calibration pattern 22b. Calibration body device 10b represented in FIG. 6 has a design at least essentially similar to calibration body device 10a described in the description of FIG. 1 through 5, so that with regard to a design of calibration body device 10b represented in FIG. 6, reference may be made at least essentially to the description of FIGS. 1 through 5. In contrast to calibration body device 10a described in the description of FIGS. 1 through 5, calibration surfaces 20b of base body 18b of calibration body device 10b represented in FIG. 6 have in each case preferably an at least essentially square base form. Base body 18b has a maximum main extension 38b of at least essentially 1 m. Calibration surfaces 20b have in each case a maximum extent 40b of at least essentially 0.71 m in parallel to cut edges 32b in each case between two of calibration surfaces 20b. Calibration body device 10b includes support elements 64b for fixing calibration surfaces 20b. Calibration body device 10b includes three support elements 64b. Support elements 64b are each provided for the purpose of fixing two of calibration surfaces 20b or two walls 24b of base body 18b forming calibration surfaces 20b in an essentially perpendicular orientation relative to one another. Support elements 64b are each designed as a support strut, which is situated in each case between two struts 26b supporting walls 24b of base body 18b. Support elements 64b are preferably situated and/or designed in such a way that, as viewed from a preferably large detection area of a detection system 17b, in particular along a detection direction of a detection system 17b, a preferably smaller portion of the three calibration surfaces 20b and/or of calibration patterns 22b are covered. Support elements 64b are fastened at struts 26b of base body 18b via screw connections. Alternatively, other designs of support elements 64b are also possible, support elements 64b being designed, for example, as an angle piece and/or being welded directly to struts 26b and/or to walls 24b. Calibration patterns 22b of calibration body device 10b each include a checkerboard pattern as well as a plurality of markers 42b, which are situated in a distributed manner, in particular, on respective calibration surface 20b at least essentially completely around the checkerboard pattern. The design of calibration body device 10b including support elements 64b is preferably not limited to exemplary embodiment b, but is also possible in combination with calibration body device 10a described in FIGS. 1 through 5. Alternatively or in addition, it is possible that calibration body device 10b is designed as part of a calibration body system that includes, in particular, multiple calibration body devices 10b.

1.-12. (canceled)

13. A calibration body device for calibrating a camera system, and/or a depth sensor, and/or a LIDAR system, and/or a radar system, the calibration body device comprising:
at least one base body which includes at least three calibration surfaces fixedly situated relative to one another and oriented differently from one another, which are configured to be radar-reflective;
wherein the at least three calibration surfaces each include at least one assignable calibration pattern.

14. The calibration body device as recited in claim 13, wherein the base body is one piece with the at least three calibration surfaces.

15. The calibration body device as recited in claim 13, wherein the at least three calibration surfaces are situated at least essentially perpendicularly to one another.

16. The calibration body device as recited in claim 13, wherein the at least three calibration surfaces each have an at least essentially planar design.

17. The calibration body device as recited in claim 13, wherein the at least three calibration surfaces are adjacent to one another, the at least three calibration surfaces forming a point of intersection and/or two each of the at least three calibration surfaces forming a cut edge.

18. The calibration device as recited in claim 13, wherein the base body has a maximum main extension of no more than 2 m.

19. The calibration body device as recited in claim 13, wherein the calibration patterns of the at least three calibration surfaces each include at least three markers formed differently from one another, the individual calibration surfaces being unambiguously identifiable via their markers and/or a spatial orientation of the individual calibration surfaces being ascertainable via the markers.

20. The calibration body device as recited in claim 13, wherein at least one calibration pattern of one of the calibration surfaces includes at least one coded piece of information, the coded piece of information being a piece of calibration information.

21. A calibration body system for calibrating a camera system, and/or a depth sensor, and/or a LIDAR system, and/or a radar system, comprising:
at least two calibration body devices, each of the calibration body devices including:
at least one base body which includes at least three calibration surfaces fixedly situated relative to one another and oriented differently from one another, which are configured to be radar-reflective,
wherein the at least three calibration surfaces each include at least one assignable calibration pattern,
wherein the calibration body devices are configured in such a way and/or are situated relative to one another in such a way that, as viewed along at least one detection direction, an unambiguous assignment of individual ones of the calibration body devices is enabled.

22. The calibration body system as recited in claim 21, wherein the at least two calibration body devices, as viewed along the detection direction are situated spaced apart from one another and offset to one another in the detection direction.

23. A method for calibrating a camera system, a depth sensor, a LIDAR system, and/or a radar system comprising:
providing a calibration body device for calibrating a camera system, and/or a depth sensor, and/or a LIDAR system, and/or a radar system, the calibration body device including:
at least one base body which includes at least three calibration surfaces fixedly situated relative to one another and oriented differently from one another, which are configured to be radar-reflective;
wherein the at least three calibration surfaces each include at least one assignable calibration pattern; and
using the calibration body device to calibrate the camera system, and/or the depth sensor, and/or the LIDAR system, and/or a radar system.

24. The method as recited in claim 11, wherein in at least one method step, at least one camera system is calibrated via a detection of at least three unambiguously assignable calibration patterns of the calibration body device, and/or at least one LIDAR system is calibrated via at least three calibration surfaces of the calibration body device and/or at least one radar system is calibrated via a reflection point for electromagnetic waves in a radio frequency range formed by the calibration surfaces, a calibration of the camera system and/or a calibration of the depth sensor and/or a calibration of the radar system, taking place at least essentially simultaneously.
